(19) United States
(12) Patent Application Publication
(10) Pub. No.: US 2026/0288940 A1
(43) Pub. Date: Sep. 24, 2026

(54) MONITORING SIDE-CHANNEL EMISSIONS

(71) Applicant: Telefonaktiebolaget LM Ericsson (publ), Stockholm (SE)

(72) Inventors: Niklas Lindskog, LUND (SE); Håkan Englund, LUND (SE); Jakob Sternby, LUND (SE)

(21) Appl. No.: 19/475,569

(22) PCT Filed: Apr. 15, 2023
(86) PCT No.: PCT/IB2023/053859

§ 371 Date: Oct. 15, 2025

(51) Int. Cl. G06F 21/55

(52) U.S. Cl. CPC G06F 21/552; G06F 2221/034

(57) ABSTRACT

One embodiment of a method performed by a monitoring device to monitor a status of a monitored device comprises obtaining a status-leakage model for the monitored device, obtaining status data from the monitored device during a status monitoring time period, obtaining side-channel emission data from one or more emissions monitoring devices during the status monitoring time period, the side-channel emission data comprising data related to side-channel emissions of the monitored device detected by the one or more emissions monitoring devices during the status monitoring time period, comparing the status data and the side-channel emission data obtained during the status monitoring time period to the status-leakage model, and determining, based on a result of the comparing, an operating state of the monitored device.

### TECHNICAL FIELD

The present disclosure relates to the monitoring of side-channel emissions of a device.

### BACKGROUND

With the rise of ubiquitous network connectivity and the proliferation of IoT devices, monitoring the operation state of connected devices has become an important field of study. Any device that is connected to an external network or exposed to physical tampering can be considered suspect. An important tool in determining the operating state of a suspect device is the monitoring of side-channel emissions. Side-channel leakage/emission is defined as a non-intended information channel from a device. Side-channel emissions include power consumption, electromagnetic (EM) emissions, thermal signatures, sound, and optical emissions. An attacker can utilize these leakages to extract sensitive information from a suspect device, e.g., to extract a cryptographic key utilized to encrypt and decrypt information. Examples of attacks leveraging side-channel emissions include methods to extract cryptographical keys from cryptographic algorithms implemented in software executing on Subscriber Identity Module (SIMs) and Central Processing Units (CPU's), as well as attacks on hardware implementations of cryptographic algorithms, examples of such cryptographic algorithms are Advanced encryption standard (AES) and Post-Quantum Cryptography (PQC)-candidates Saber & KYBER. Side-channel emissions can also be used to reverse engineer software running on a CPU or microcontroller. Some side-channel leakage types, such as electromagnetic, thermal, and optical emissions, are sensitive to probe placement. As a result, it is important to measure in the same relative position to the suspect device to obtain data from two different measurement suites that can be correlated.

The side-channel emissions emitted by the suspect device are typically unintended, and although sometimes maliciously exploited by attackers to extract secrets, the side-channel emissions can also be used to monitor the state of the suspect device as a means of detecting the presence of malicious software and/or hardware alterations. In these cases, an external monitoring device registers the side-channel leakage from the suspect device and determines if the suspect device behaves normally according to pre-defined criteria. Several methods for side-channel monitoring exist, and in some solutions, the monitoring device is oblivious to the internal state of the suspect device and only determines “normal” or “abnormal” side-channel leakage. In other solutions, the monitoring device can connect certain states or operations within the suspect device to certain side-channel emission patterns. The latter may also detect “illegal” state transitions within an execution, i.e., where the execution flow of the device is abnormal. The most prominent advantage of side-channel monitoring is that it is very hard for the suspect device to avoid or intentionally shape the side-channel leakages, and the monitoring device may be physically separated from the suspect device. This combination makes it very hard for an attacker to remain undetected, as an attack on a suspect device will unavoidably cause abnormal changes in the side channel leakage. This is beneficial in both high-security environments and as a complement to “classic” monitoring solutions. Low-cost generic hardware for side channel emissions measurements is widely available, such as the NewAE's ChipWhisperer series. Remote side-channel monitoring means that the monitoring device utilizes a component or device external to itself to monitor the device under monitoring.

A suspect device that has been infected by malware can act normally towards a monitoring device by detaching the internal measurements with the status data supplied to the monitoring device. Stuxnet is probably the most well-known example of this type of sophisticated malware containing code that faked sensor signals so that a suspect device would not shut down due to abnormal behavior. Stuxnet was likely designed to target Uranium enrichment facilities. By forcing the system sensors of the suspect device to report normal behavior, the monitoring device failed to safeguard the suspect device from operations that were detrimental to the underlying hardware. In this particular example, centrifuges were overdriven in separating nuclear material to such an extent that the centrifuges failed. Up to 1000 centrifuges were reportedly destroyed by the Stuxnet malware during a period of a few years. As Stuxnet and similar malware install rootkits, they affect side-channel emission patterns from the attacked component. Creating malware that manages to allow a suspect device to continue to perform its original target task without affecting side-channel emissions would be an extremely complex problem, and while some limited academic progress has been made in this field, having to minimize differences in side-channel leakage raises the bar significantly for an attacker.

Another threat against suspect devices, especially in the IoT sector, is that the suspect devices are infected with malware and, unbeknownst to the owner, become part of a botnet. This type of attack utilizes the suspect devices compute resources to perform, e.g., denial-of-service (DoS) attacks and malware distribution attacks (spreading malware to other devices). The Mirai botnet is a prominent example of such a malware infection, infecting upwards of 400000 devices. The malware infection is invisible to a monitoring device, such as a smart home hub, as the compromised suspect device continues to function normally (albeit with additional network traffic and slower performance).

What is needed are techniques that combine the status information obtained from the suspect device being monitored and the side channel emissions measured from an external device to infer the operating state of the suspect device. Further techniques are needed that allow multiple separate devices to aid in the measurement of the suspect device.

### SUMMARY

In one embodiment, a method of operating a monitoring device to monitor a status of a monitored device comprises obtaining a status-leakage model for the monitored device, obtaining status data from the monitored device during a status monitoring time period, obtaining side-channel emission data from one or more emissions monitoring devices during the status monitoring time period, the side-channel emission data comprising data related to side-channel emissions of the monitored device detected by the one or more emissions monitoring devices during the status monitoring time period, comparing the status data and the side-channel emission data obtained during the status monitoring time period to the status-leakage model, and determining, based on a result of the comparing, an operating state of the monitored device.

In one embodiment, obtaining the status-leakage model comprises receiving enrollment status data from the monitored device during an enrollment time period, receiving enrollment side-channel emission data from the one or more emissions enrolling devices during the enrollment time period, and building the status-leakage model for the monitored device based on the enrollment status data and the enrollment side-channel emission data.

In one embodiment, obtaining the status-leakage model further comprises transmitting an instruction to the one or more emissions enrolling devices that identifies a location at which the enrollment side-channel emissions of the monitored device should be measured, prior to receiving the enrollment side-channel emission data from the one or more emissions enrolling devices during the enrollment time period.

In one embodiment, obtaining the status-leakage model further comprises, establishing a first secure communication channel between the monitoring device and the monitored device prior to receiving the enrollment status data from the monitored device during the enrollment time period, and establishing a second secure communication channel between the monitoring device and the one or more emissions enrolling devices prior to receiving the enrollment side-channel emission data from the one or more emissions enrolling devices during the enrollment time period.

In one embodiment, obtaining the status-leakage model further comprises resetting the monitored device to a known state prior to receiving the enrollment status data from the monitored device during the enrollment time period.

In one embodiment, obtaining the status-leakage model further comprises transmitting a message to at least one of the one or more emissions enrolling devices requesting a start to side-channel monitoring of the monitored device.

In one embodiment the message comprises information identifying one or more of, an identity and/or a geolocation of the monitored device, a desired side-channel emission of the monitored device to measure, an instruction identifying a location at which the enrollment side-channel emissions of the monitored device should be measured, an instruction identifying a technique to employ in measurement of the enrollment side-channel emissions of the monitored device, and a side-channel measurement capability of the one or more emissions enrolling devices.

In one embodiment the message further comprises additional information that identifies a duration of the enrollment side-channel emissions to be measured, and a time at which a scheduled process will occur on the monitored device.

In one embodiment the status-leakage model comprises the enrollment status data obtained during the enrollment time period, the enrollment side-channel emission data obtained during the enrollment time period, and a mapping between the enrollment status data obtained during the enrollment time period and the enrollment side-channel emission data obtained during the enrollment time period.

In one embodiment the status-leakage model further comprises a type of side-channel emission being measured by the side-channel monitoring by the one or more emissions enrolling devices, a setup of one of the one or more emissions enrolling devices performing measurement of the enrollment side-channel emissions, a location for side-channel emissions measurement by the one or more emissions enrolling devices, and a disposition for side-channel emissions measurement by the one or more emissions enrolling devices.

In one embodiment obtaining the side-channel emission data comprises transmitting a message to the one or more emissions monitoring devices requesting side-channel monitoring of the monitored device, receiving the status data from the monitored device and the side-channel emission data measured by the one or more emissions monitoring devices, combining the status data and the side-channel emission data to form a combined data, and comparing the combined data to a status-leakage model tuple.

In one embodiment obtaining side-channel emission data further comprises transmitting an instruction to the monitored device to execute a process, the execution of the process by the monitored device resulting in a changed monitored status data.

In one embodiment the method further comprises transmitting an instruction to the monitored device to perform a reset, receiving additional measurements of the side-channel emission data from one of the one or more emissions monitoring devices, and determining from the additional measurements of the side-channel emission data that the reset was performed by the monitored device.

In one embodiment the status data and the side-channel emission data to the status-leakage model comprises performing a comparison of the status data and the side-channel emission data to the status-leakage model using a machine learning model where the side-channel emission data is evaluated as anomalous when the machine learning model produces a low likelihood of the side-channel emission data when correlated to status data.

In one embodiment determining the operating state of the monitored device comprises determining that the operating state of the monitored device is one of operating normally and not operating normally.

In one embodiment comparing the status data and the side-channel emission data to the status-leakage model comprises determining an enrollment profile based on the status-leakage model, determining a monitored profile based on the status data received from the monitored device and monitored side-channel emission data received from the one or more emissions monitoring devices, and comparing the enrollment profile to the monitored profile.

In one embodiment comparing the enrollment profile to the monitored profile comprises determining an enrollment mapping between the enrollment status data and the enrollment side-channel emission data, and determining a monitored mapping between the status data and the side-channel emission data.

In one embodiment determining the operating state of the monitored device comprises determining the operating state of the monitored device based on the result of the comparing and one or more external factors.

In one embodiment the one or more the external factors interfere with a measurement of the side-channel emission data, the one or more external factors including weather, humidity, air pressure, and lighting conditions and the side-channel emission data comprising one or more of: electromagnetic emissions from the monitored device, optical emissions from the monitored device, and acoustic emissions from the monitored device.

In one embodiment the method further comprises, in response to determining the operating state of the monitored device, initiating isolation procedures against the monitored device.

In one embodiment initiating the isolation procedures comprises revoking an access to information by the monitored device, and instructing one or more devices to cease communication with the monitored device.

In one embodiment the method further comprises comparing the enrollment side-channel emission data to a threshold, wherein the determining the operating state of the monitored device comprises determining the operating state of the monitored device based on both the result of the comparing the status data and the side-channel emission data to the status-leakage model and a result of the comparing the enrollment side-channel emission data to the threshold.

In one embodiment the one or more emissions enrolling devices are one or more emissions measuring devices performing measurement of the side-channel emission data during the enrollment time period, and the one or more emissions monitoring devices are one or more emissions measuring devices performing side-channel emissions measurement of the side-channel emission data during the monitoring time period.

In one embodiment the one or more enrolling monitoring devices and the one or more emissions monitoring devices include overlapping devices, or do not include overlapping devices, or is a same device, or include at least one autonomous device adapted to move without physical human manipulation.

In one embodiment the enrollment side-channel emission data and second side-channel emission data comprises any one or more of power consumption of the monitored device, electromagnetic emissions from the monitored device, timing signals of the monitored device, optical emissions from the monitored device, acoustic emissions from the monitored device, and heat emissions from the monitored device.

In one embodiment obtaining the status-leakage model for the monitored device comprises obtaining an identifier identifying the monitored device, obtaining, based on the identifier, the status-leakage model of the monitored device, obtaining setup configuration information from the status-leakage model of the monitored device, and determining an emissions monitoring device based on the setup configuration information.

An advantage of the proposed system is that status data is collected from a suspect device during a known uncompromised operating state, and simultaneously side-channel emission data is collected from a measurement device which is separate from the suspect device and monitoring device. The status data and emission data are used together to form a model showing the mapping between the status data and the emission data when the suspect device is operating normally. The model can then be compared to status data and side-channel emission data collected at a later time when the suspect device is deployed in the field to determine the operating state of the suspect device. Further advantages include the suspect device not needing monitoring capabilities of its own and the system retaining the flexibility to use different arrangements of measurement devices. Further, the system is scalable, and the same monitoring device can be used to monitor multiple suspect devices with corresponding measurement devices.

### BRIEF DESCRIPTION OF THE DRAWINGS

The accompanying drawing figures incorporated in and forming a part of this specification illustrate several aspects of the disclosure and together with the description, serve to explain the principles of the disclosure.

FIG. 1 illustrates one example of a system architecture for enrollment and monitoring of side-channel emissions;

FIG. 2A illustrates one example of the elements of a status-leakage model;

FIG. 2B illustrates one example of the elements of monitored status data;

FIG. 3A illustrates the steps of the enrollment phase for monitoring side channel emissions;

FIG. 3B illustrates the additional steps of the enrollment phase for the monitoring of side-channel emissions;

FIG. 4A illustrates the steps of the monitoring phase for the monitoring of side-channel emissions;

FIG. 4B illustrates additional steps of the monitoring phase for the monitoring of side-channel emissions;

FIG. 5A illustrates an enrollment phase profile for an exemplary use case of monitoring the side channel emissions of an IoT lighting device;

FIG. 5B illustrates a monitoring phase profile for an exemplary use case of monitoring the side channel emissions of an IoT lighting device;

FIG. 5C illustrates another monitoring phase profile for an exemplary use case of monitoring the side channel emissions of an IoT lighting device;

FIG. 6A illustrates the method steps for operating a monitoring device to monitor the status of a monitored device using one or more emissions monitoring devices to determine the operating state of the monitored device;

FIG. 6B illustrates the additional method for steps operating a monitoring device to monitor the status of a monitored device using one or more emissions monitoring devices to determine the operating state of the monitored device; and

FIG. 6C illustrates the additional method steps for operating a monitoring device to monitor the status of a monitored device using one or more emissions monitoring devices to determine the operating state of the monitored device.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

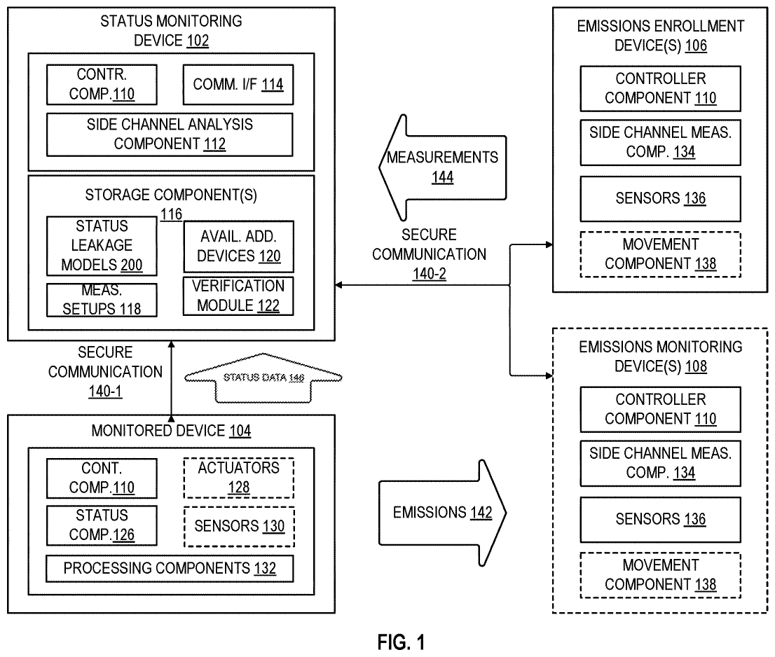

FIG. 1 illustrates one example of a system architecture for enrollment and monitoring of side-channel emissions. The simplest embodiment involves three entities: a monitoring device 102 for controlling the monitoring through a verification module, a monitored device 104 that is being monitored, and an emissions enrolling device 106 that collects measurements on the side-channel emissions. The method is performed in two distinct phases: enrollment and monitoring. The monitoring device 102 monitors a monitored device 104 by continuously receiving sets of status data 146 from the monitored device 104 via the status component 126. The status component 126 can be hardware, software, or any combination thereof. In some embodiments, the status component 126 is integrated with the controller component 110 but is not limited thereto. The monitoring device 102 intermittently utilizes an emissions enrolling device 106 from a set of several available additional emissions measuring devices 120 to collect side-channel measurements 144 on the monitored device 104. The monitored device 104 uses the side-channel measurement component 134 to both collect the side-channel measurements 144 and transmit the side-channel measurements 144 to the monitoring device 102.

At a first point in time during an enrollment phase, the monitoring device 102 sends out a message over secure communications 140-2 to the emissions enrolling device 106 from the set of available additional emissions measuring devices 120 requesting side-channel monitoring of the monitored device 104. The side-channel measurement component 134 uses the movement component 138 to control the disposition of the emissions enrolling device 106 in relation to the monitored device 104 to optimize measurement fidelity. The side-channel measurement component 134 can be hardware, software, or any combination thereof. In some embodiments, the side-channel measurement component 134 is integrated with the controller component 110 but is not limited thereto. As used herein, disposition refers to the way a device is placed or arranged, especially in relation to another device. The movement component 138 uses one or more actuators to control the disposition of the emissions enrolling device 106. Examples of actuators include electric motors, stepper motors, jackscrews, and the like. The side-channel measurement component 134 uses one or more sensors 136 to collect the side-channel emissions 142 data. The two most common side-channel emissions 142 are electromagnetic emissions and power consumption, but the described method can also utilize acoustic emissions, optical emissions, heat emissions, and/or timing of processes or externally observable events. The monitoring device 102 receives status data 146 over secure communications 140-1 from the monitored device 104, and side-channel emissions 142 are measured by an emissions enrolling device 106 from the set of available additional emissions measuring devices 120. The monitoring device 102 builds a status-leakage model 200 from the side-channel emissions 142 and maps the status data 146 to the status-leakage model 200 as a tuple. As used herein, a tuple refers to an ordered list or sequence of elements. In the case of the status-leakage model 200, the status data/side-channel emission data pairs form the elements in the sequence.

At a second point in time during the monitoring phase, the monitoring device 102 transmits a message over secure communications 140-2 to at least one device in the set of available additional emissions measuring devices 120 requesting side-channel monitoring of the monitored device 104. This message further contains configuration information defining which measurements 144 should be sampled and how the measurements 144 should be obtained by the emissions enrolling device 106. The monitoring device 102 receives status data 146 over secure communications 140-1 from the monitored device 104 and side-channel emissions 142 measured by an emissions monitoring device 108 from the set of available additional emissions measuring devices 120. The monitoring device 102 combines the status data 146 and side-channel emissions 142 and compares this to the relevant status-leakage model 200 tuple.

The monitoring device 102 continuously matches the measurements 144 obtained during the monitoring phase with the status-leakage model 200 tuple to determine an operating state of the monitored device 104. The operating state can be determined by continuously comparing the measurements 144 and status data 146 obtained during the monitoring phase with the status-leakage model 200 tuples collected during the enrollment phase until a threshold is met, indicating that the status data 146 is trustworthy or not trustworthy and thus identifying the operating state of the monitored device 104. The side-channel measurements 144 may be any of power consumption, electromagnetic emissions, timing, optical emissions, acoustic emissions, and the like.

The emissions enrolling device 106 and emissions monitoring device 108 may be the same device or different devices. In some embodiments, the monitoring device 102 monitors multiple monitored devices 104 using multiple emissions enrolling devices 106. In some embodiments, the monitoring device 102 simultaneously monitors multiple monitored devices 104 using multiple emissions monitoring devices 108.

In some embodiments, the enrollment phase for a monitored device 104 may be omitted, and instead the monitoring device 102 may use pre-recorded status-leakage model 200 data from at least one device of the same type. Using pre-recorded status-leakage model 200 data can be advantageous in scenarios where a plurality of monitored devices 104 have been measured using slightly different dispositions (position, tilt, distance, etc.), making the measurements 144 less sensitive to the exact disposition of the emissions enrolling device 106/emissions monitoring device 108.

In some embodiments, to simplify the mapping of side-channel emissions 142 and status data 146, the monitored device 104 may produce a “marker” side-channel pattern to indicate to the emissions enrolling device 106 when a certain target operation starts/ends. The “marker” side-channel pattern may be produced by the monitored device 104 entering an operating state not normally entered during regular operations to make it easy to distinguish such a “marker” pattern from other side-channel emissions 142. Optionally, the operations performed by the monitored device 104 can be triggered by the monitoring device 102, and the “marker” side-channel pattern can be produced when the target operation starts and/or ends.

In some embodiments, the monitoring device 102 and the emissions enrolling device 106 synchronize their respective system time before the measurements start. The time synchronization can be performed in a peer-to-peer fashion or via a third party such as a time server.

During the enrollment procedure, it may be necessary for the monitored device 104 to execute a large portion of the expected instructions or sequences of instructions multiple times so that the monitoring device 102 can derive well-formed status-leakage models 200 of emissions 142 for benign sequences of operations. This enrollment training includes producing different values for expected branching instructions and can result in a large set of status-leakage models 200 and measurements 144. The monitored device 104 can be pre-configured with known sequences that should all be sequentially executed during the enrollment. These known sequences can be incorporated into, e.g., the firmware or in ROM code in the hardware of the monitored device 104. The sequences may be known to the emissions enrolling device 106 beforehand (e.g., supplied in the enrollment request from the monitoring device 102 and/or may broadcast from the monitored device 104, enabling the emissions enrolling device 106 to receive an enrollment start time. When executed on the monitored device 104, the known sequences are logged with timing information (timestamps) and transmitted to the monitoring device 102.

The controller component 110, including one or more processors and one or more memories, can be implemented in any technically feasible fashion. For example, and without limitation, in various embodiments, any combination of processor and memory can be implemented as a stand-alone chip or as part of a more comprehensive integrated solution that is implemented as an application-specific integrated circuit (ASIC), a system-on-a-chip (SoC), and/or the like. The one or more controller components 110 can include any suitable processor, such as a central processing unit (CPU), a digital signal processor (DSP), a graphics processing unit (GPU), an application-specific integrated circuit (ASIC), a field programmable gate array (FPGA), a tensor processing unit (TPU), a microprocessor (e.g., ARM M4), any other type of processing unit, or a combination of multiple processing units, such as a CPU configured to operate in conjunction with a GPU. In general, each of the one or more controller components can be any technically feasible hardware unit capable of processing data and/or executing software applications and modules that are used to manage and control devices such as the monitoring device 102, monitored device 104, emissions enrolling device 106, and emissions monitoring device 108. Controller component 110 is communicatively coupled with a side-channel analysis component 112, communications interface(s) 114, and storage component(s) 116, via one or more interconnectors or buses. The side-channel analysis component 112 performs side-channel analysis using the status data 146 and measurements 144. The side-channel analysis component 112 can be hardware, software, or any combination thereof. In some embodiments, the side-channel analysis component 112 is integrated with the controller component 110 but is not limited thereto. In some embodiments, side-channel analysis component 112 performs hardware acceleration for machine learning (ML) functions such as neural network acceleration. The communications interface(s) 114 is an interface such as an Ethernet interface, WIFI, Bluetooth, or the like. However, the present disclosure is not limited thereto. The storage component(s) 116 are digital data storage components such as, for example, one or more hard disk drives and/or solid-state devices (SSDs). However, the present invention is not limited thereto.

The measurement setups 118 include configuration data specifying how the additional emissions measuring devices 120 should be disposed to best accomplish a side channel emission data measurement. The disposition information includes items such as the distance between the device measuring side channel emissions (emissions enrolling device 106 or emissions monitoring device 108), the device being measured (monitored device 104), and the orientation of the device taking measurements (emissions enrolling device 106 or emissions monitoring device 108) in relation to the device (such as roll pitch and yaw).

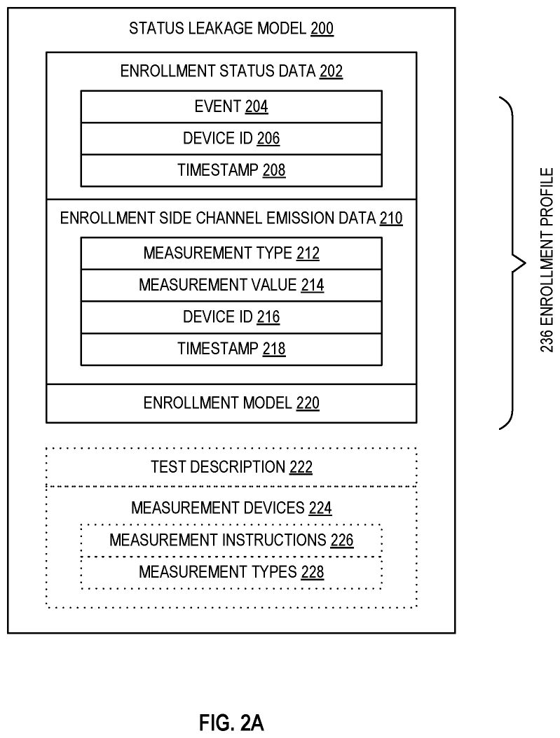

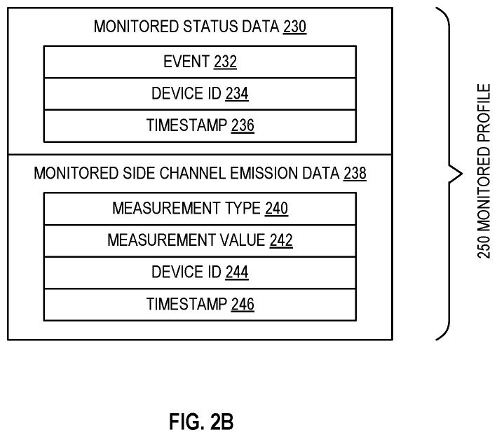

FIG. 2 illustrates one example of the elements of a status-leakage model 200. The status-leakage model, 200 stores information, collected during the enrollment phase and monitoring phase of the monitoring process. During the enrollment phase, an enrollment profile 236 is constructed, including enrollment status data 202, the enrollment side-channel emission data 210, and enrollment model 220. The enrollment status data 202 stores status data from the monitored device 104 during the enrollment time period. The status data includes one or more events 204 caused by the execution of instructions on the monitored device 104. The event 204 may be timestamped by the monitored device 104 to provide a timestamp 208 that identifies the time at which the event 204 occurred. The events 204 may also be marked with a device id 206 indicating the device on which the event 204 occurred. The enrollment side-channel emission data 210 stores information related to the side-channel emissions measured (or sampled) by one or more emissions monitoring devices 108 during the enrollment time period. The measurements may include a measurement type 212, one or more measurement values 214, device ID 216, and a timestamp 218. The measurement type 212 identifies the type of measurement being sampled. Examples include power consumption, electromagnetic emission, timing of processes or externally observable events in the monitored device, optical emission, acoustic emission, and heat emission. The measurement values 214 identifies the values of the measurement being sampled. The units and value of the measurement being sampled are dependent on the measurement type 212. The device id 216 is a unique identifier identifying the device taking the measurement. The timestamp 218 is assigned by the monitored device 104 and identifies the time at which the measurement was sampled. The enrollment model 220 stores a measure of the relationship or connection between the enrollment status data 202 and the enrollment side-channel emission data 210.

The status-leakage model 200 optionally stores information related to the side-channel emissions 142 measurements 144, including a test description 222, measurement devices 224, measurement instructions 226, and measurement types 228. The test description 222 stores a description of the type of test performed during enrollment. The measurement devices 224 store a listing of the one or more emissions monitoring devices 108 used during the side-channel emissions measurement. The measurement devices are identified by device id 206. The measurement instructions 226 store a listing of the instructions sent to the one or more emissions monitoring devices 108 used during the side-channel emissions measurement. Examples include a cell phone, light meter, EMF meter, UAV, etc. The measurement types 228 stores a listing of the types of measurement measured during the collection of enrollment side-channel emission data 210.

The monitored device 104 further includes processing component(s) 132 to receive and respond to instructions from the monitoring device 102. The processing component(s) 132 can be hardware, software, or any combination thereof. In some embodiments, the processing component(s) 132 are integrated with the controller component 110 but are not limited thereto. The monitored device 104 may also include optional actuators 128 and sensors 130. The sensors 130 include sensors previously described as sensors 136. The actuators may include components such as those described in movement components 138 and may also include non-mechanical components such as a solid state electrical relay suitable to control a light.

FIG. 2B illustrates one example of the elements of monitored status data. During the monitoring phase, a monitored profile 250 is constructed which includes the monitored status data 230, the monitored side-channel emission data 238. The monitored status data 230 shares the same definition as the enrollment status data 202, with the exception that it is collected during the monitoring phase. Likewise, the monitored side-channel emission data 238 shares the same definition as the enrollment side-channel emission data 210 with the exception that it is collected during the monitoring phase The monitored status data and the monitored side channel emission data are evaluated against the enrollment model and a decision is made as to whether the two are matched.

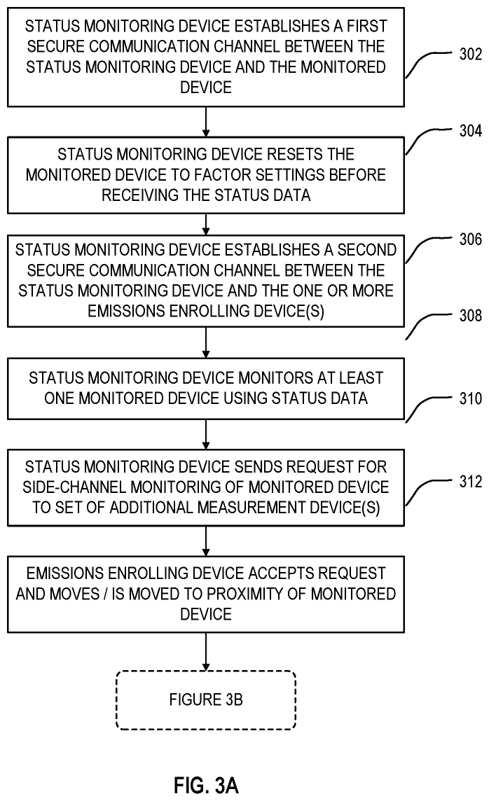

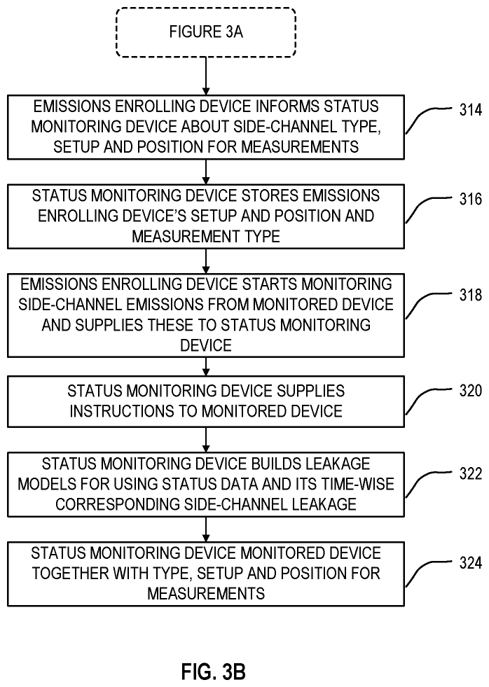

FIG. 3A illustrates the steps of the enrollment phase for monitoring side channel emissions. At step 302, the verification module 122 of the monitoring device 102 establishes first secure communications 140-1 between the monitoring device 102 and the monitored device 104. At step 304, the verification module 122 resets the monitored device 104 to a known state (such as the factory settings) before receiving the enrollment status data 202. At step 306, the verification module 122 of monitoring device 102 establishes second secure communications 140-2 between the monitoring device 102 and the one or more emissions enrolling devices 106. At step 308, the verification module 122 monitors the health, state, and/or current processes of the monitored device 104 by optionally requesting and receiving enrollment status data 202 from the monitored device 104. At step 310, the verification module 122 selects at least one emission enrolling device 106 from the set of available additional emissions measuring devices 120 and supplies a request for side-channel enrollment. The request includes at least the identity and/or position of the monitored device 104 and the desired type of side-channel emission 142 to measure. The requests may optionally include where, what, and how to measure on the monitored device 104. The instruction may be one or more of an image of the measuring point, relative distance to a physical property on the device, duration of the measurement, specific side-channel measurement capability (e.g., a certain probe type), and specific timings for measurements (for example when known scheduled processes occur on monitored device 104. At step 312, the verification module 122 awaits confirmation from at least one emissions enrolling device 106, from the set of available additional emissions measuring devices 120 that it will move to the proximity of the monitored device 104 (either autonomously or by human interaction) to perform said request. As used herein, autonomous means that a device is operable to move itself without physical human manipulation.

FIG. 3B illustrates additional steps for the enrollment phase for monitoring of side channel emissions. FIG. 3B picks up where FIG. 3A ends. At step 314, the verification module 122 optionally receives an indication from the emissions enrolling device 106 that it has reached the proximity of the monitored device 104. The monitoring device 102 may further optionally request cryptographical proof of proximity before accepting any measurements from the emissions enrolling device 106. For example, a data structure including (position, internal sensor measurements, and/or images) signed with a cryptographic key. At step 316, the verification module 122 stores the geolocation and other relevant setup information that can impact the measurements from the emissions enrolling device 106. E.g., gyroscope information (position, tilt), distance to the device, and current environmental conditions. If the emissions enrolling device 106 has a dedicated side-channel probe, the exact placement of said probe may be stored instead of device position. At step 318, the emissions enrolling device 106 starts to measure the side-channel emissions 142 from the monitored device 104 or, alternatively, receives a start signal from the monitoring device 102. The verification module 122 receives the measurements 144 from the emissions enrolling device 106, either one at a time or in bulk transmissions. The monitoring device 102 correlates the enrollment status data 202 received from the monitored device 104 and the side-channel emissions 142 from the emissions enrolling device 106. At step 320, the verification module 122 requests the emissions enrolling device 106 to initiate the enrollment procedure. In the enrollment procedure, the monitored device 104 executes sequences of instructions with the goal of maximizing code coverage of the measurements 144. The procedure may involve executing the same routines multiple times to smooth out noise in the measurements 144. In one embodiment, the enrollment sequence is prerecorded and determined based on an identifier of the monitored device 104.

The verification module 122 may optionally send an instruction to the monitored device 104 to perform certain procedures and thereby change its status. The side-channel emissions 142 occurring from the monitored device 104 performing these instructions are recorded by the emissions enrolling device 106. The monitored device 104 may optionally provide synchronization information directly to the emissions enrolling device 106 via external peripherals, such as LEDs. Such information can simplify time synchronization etc. The emissions enrolling device 106 may optionally measure emissions 142 from one or several additional side channels. Alternatively, or additionally, the emissions 142 may be measured with a different setup (different position, tilt, etc.).

The emissions enrolling device 106 ceases to measure the monitored device 104, either by reaching the end of a timer or by explicit instruction from the monitoring device 102. At step 322, the verification module 122 derives status-leakage models 200 for sequences of instructions. A status-leakage model 200 is a statistical model which defines the specific characteristics of the side-channel leakage for one or more sets of enrollment status data 202. Optionally, creating the status-leakage model 200 may involve the monitoring device 102 training a machine learning model to detect different states by using the knowledge of the side-channel emissions 142 and the status data 146. This can be accomplished by training an ML-model on side-channel emissions 142 resulting from known instructions during the enrollment phase. During the monitoring phase, new side-channel measurements 144 are evaluated by the ML-model, which can be made to produce a score indicating how well the new measurements correlate with expectations. In one embodiment, the ML-model is trained on measurements 144 resulting from instructions executed on the monitored device 104 during the enrollment phase. In a second embodiment, the specific models are trained based on measurements 144 resulting from a specific set of instructions where the mapping between measurements and instructions is known by the monitoring device 102. At step 324, the verification module 122 stores the status-leakage model 200.

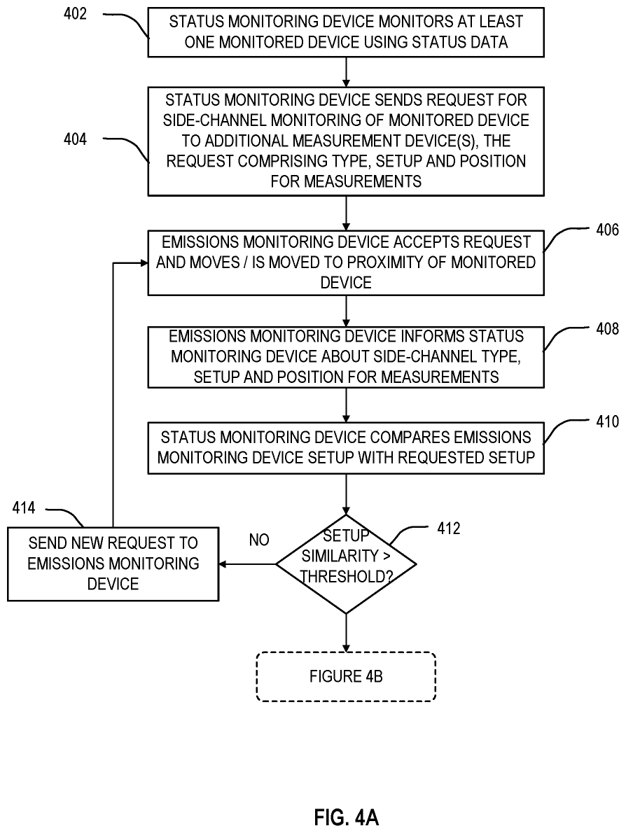

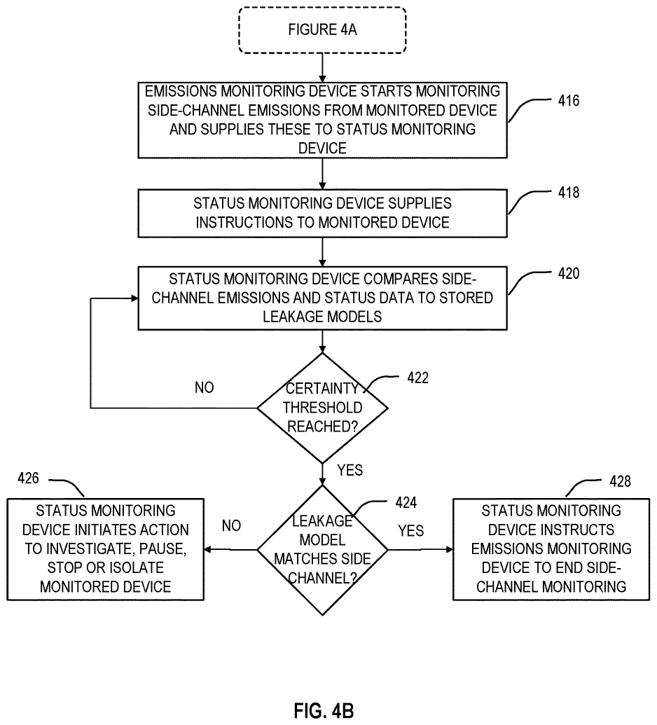

FIG. 4A illustrates the steps of the monitoring phase for the monitoring of side channel emissions. At step 402, the verification module 122 of the monitoring device 102 monitors the health, state, and current processes of the monitored device 104 by requesting and receiving monitored status data 230 from the monitored device 104. At step 404, the verification module 122 determines that side-channel monitoring of the monitored device 104 is needed. This can be triggered by a timer expiring or by receiving certain monitored status data 230.

The monitoring device 102 may optionally receive an external indication that the monitored device 104 requires monitoring. For example, the monitoring device 102 may receive a message from another monitored device that the monitored device 104 is not responding properly and/or is transmitting communication packages in an abnormal manner. It could also be an operator requiring an extra monitoring based on the current threat status.

The verification module 122 selects at least one emissions monitoring device 108 from the set of available additional emissions measuring devices 120 and supplies a request for side-channel enrollment. The set of available additional emissions measuring devices 120 may be the same or a different set of devices employed during the enrollment phase. The emissions monitoring device 108 may be equal to, or a different device than, the emissions enrolling device 106. The request includes at least: the identity and/or geolocation of the monitored device 104, the desired side-channel emission type to measure, where and how to measure on the monitored device 104 (including, for example, device position, tilt, distance to device, etc.), a specific side-channel measurement capability (e.g., a specific probe to use). The request can optionally include a duration of the measurement and specific timings for measurements (e.g. when known scheduled processes occur on the monitored device 104. At step 406, the verification module 122 awaits confirmation from at least one emissions monitoring device 108 that it will move to the proximity of the monitored device 104 (either autonomously or by human interaction) to perform said request. The emissions monitoring device 108 may be equal to the emissions enrolling device 106, or alternatively, a different device with the same side-channel measurement capability.

At step 408, the verification module 122 optionally receives an indication from the emissions monitoring device 108 that it has reached the proximity of the monitored device 104. The monitoring device 102 may optionally request cryptographical proof of proximity (device position, tilt, etc.) before accepting any measurements from the emissions monitoring device 108. The proof may take the form of a data structure including a geolocation, internal sensor measurements, and/or image signed with a cryptographic key or communicated via a secure communication channel).

At steps 410 and 412, the verification module 122 compares the current measurement properties to the stored measurement properties and determines an expected mapping.

FIG. 4B illustrates additional steps for the monitoring phase for monitoring of side channel emissions. FIG. 4B picks up where FIG. 4A ends. At step 414, the emissions monitoring device 108 is instructed to change its position. At step 416, the emissions monitoring device 108 starts to measure the side-channel emissions 142 from the monitored device 104, or alternatively, receives a start signal from the monitoring device 102. The verification module 122 of monitoring device 102 receives the measurements 144 from the emissions monitoring device 108, either individually or in bulk transmissions. The monitoring device 102 correlates the monitored status data 230 received from the monitored device 104 and the side-channel emissions 142 from the emissions monitoring device 108.

At step 418, the verification module 122 of the monitoring device 102 optionally sends an instruction to the monitored device 104 to perform certain procedures and thereby change the status of the monitored device 104. The side-channel emissions 142 emitted from the monitored device 104 performing the instructions are recorded by the emissions enrolling device 106.

At steps 420 to 424, the verification module 122 compares the side-channel emissions 142 stored during the enrollment phase by finding matching monitored status data 230, stored in the enrollment phase, and comparing the difference in the side-channel emissions 142.

The verification module 122 may optionally perform post-processing of the side-channel emissions 142 by performing dynamic time warping to better match the timing of the side-channel emissions 142 to corresponding instructions. External environmental factors, including weather, temperature, humidity, and light, may optionally be taken into consideration when considering matching thresholds. E.g., more deviance in the model accuracy may be allowed if the measured side-channel is electromagnetic and it is raining. The comparison may optionally be performed by a machine learning model where new measurements are evaluated as anomalous when the ML-model produces a low likelihood of the new measurements taking into account the status, environmental factors and processed instructions. For some ML-models, the likelihood may be expressed as an anomaly score, in which case a high score implies a low likelihood. In both cases, a threshold value can be set to determine whether the instructions corresponding to the measurements are consistent with a monitored device 104 that has not been tampered with.

At step 426, if the monitored device 104 is determined to not be acting normally, the verification module 122 may take one of several actions, including sending instructions to the monitored device 104 to reset the monitored device 104 to a known state, such as initiating a reset of the monitored devices 104 (and determining from the emissions monitoring device 108 if the reset is carried out correctly), initiating isolation procedures of monitored device 104 (such as revoking any privileged access to information), instructing other monitored devices to cease communication with the monitored device 104; and initiating further investigations of monitored device 104. At step 428, if the side-channel emissions 142 match probability is above a certain threshold, the side-channel monitoring is ended.

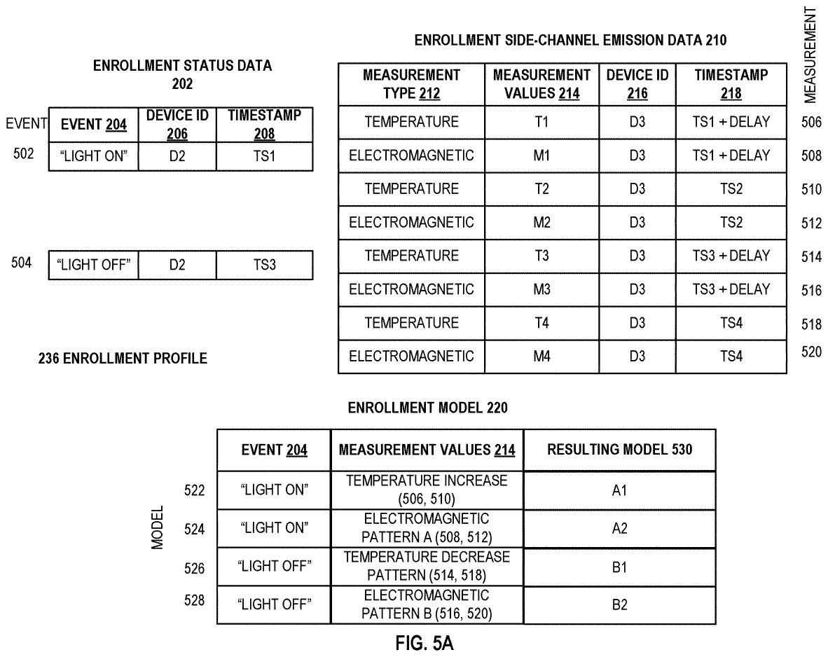

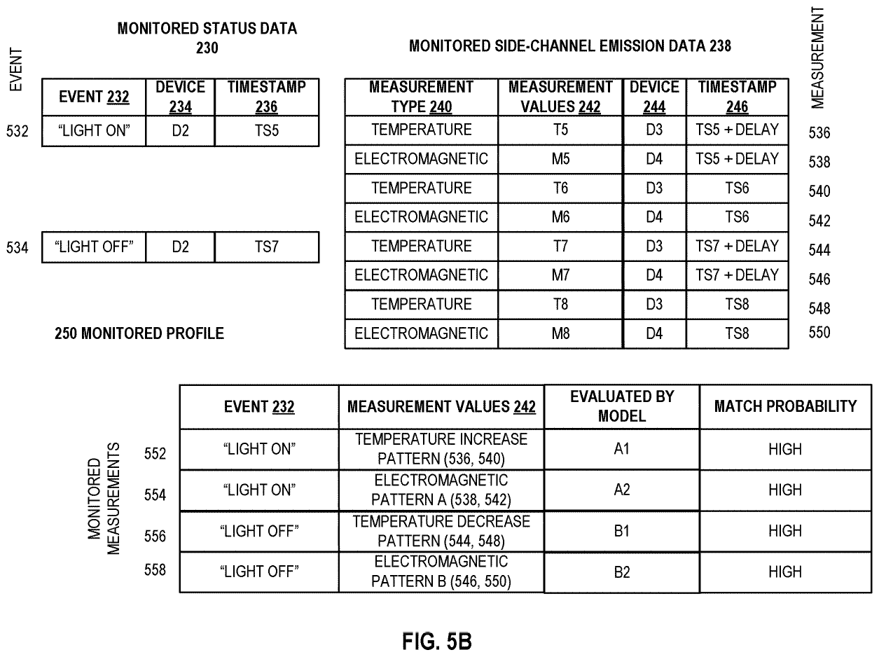

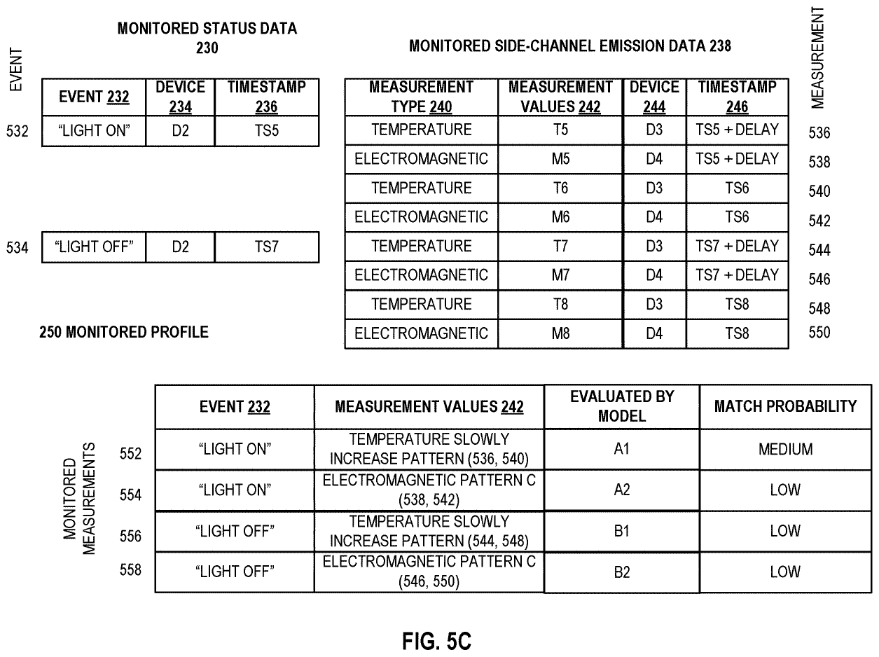

FIG. 5A illustrates an enrollment phase profile for an exemplary IoT smart lighting device. The side-channel enrollment is performed by an emissions enrolling device 106 that is equipped to measure both heat and light emissions from which the enrollment profile 236 is constructed. In this hypothetical example, the IoT lighting device outputs light and a small amount of heat when turned on.

During the enrollment phase, the verification module 122 communicates with the monitored device 104 to determine the enrollment status data 202. At time “TS1”, event 502 identifies that a “light on” has occurred on device “D2” corresponding to monitored device 104. At time “TS3”, event 504 identifies that a “light off” has occurred on device “D2” corresponding to monitored device 104.

In parallel, the verification module 122 communicates with the emissions enrolling device 106 to determine the enrollment side-channel emission data 210. At time “TS1+DELAY”, measurement 506 identifies that “TEMPERATURE” measurement values “T1” were recorded at device “D3”. At time “TS1+DELAY”, measurement 508 identifies that “ELECTROMAGNETIC” measurement values “M1” were recorded at device “D3”. At time “TS2”, measurement 510 identifies that “TEMPERATURE” measurement values “T2” were recorded at device “D3”. At time “TS2”, measurement 512 identifies that “ELECTROMAGNETIC” measurement values “M2” were recorded at device “D3”. At time “TS3 +DELAY”, measurement 514 identifies that “TEMPERATURE” measurement values “T3” were recorded at device “D3”. At time “TS3+DELAY”, measurement 516 identifies that “ELECTROMAGNETIC” measurement values “M3” were recorded at device “D3”. At time “TS4”, measurement 518 identifies that “TEMPERATURE” measurement values “T4” were recorded at device “D3”. At time “TS4”, measurement 520 identifies that “ELECTROMAGNETIC” measurement values “M4” were recorded at device “D3”.

As can be seen from the enrollment data, the verification module 122 sends instructions to the monitored device 104 directing the monitored device 104 to turn a light on at event 502. In parallel, at emissions enrolling device 106, measurements 506 and 508 are recorded, storing the electromagnetic emissions from the processes in the monitored device 104 corresponding to light being emitted (indicated by M1) and an initial temperature pattern is present (indicated by T1). Measurements 510 and 512 are also recorded, storing the emissions from the processes in the monitored device 104 corresponding to a light still being present (indicated by M2) and an increased temperature pattern (indicated by T2).

The verification module 122 sends instructions to the monitored device 104 directing the monitored device 104 to turn a light off at event 504. In parallel, at emissions enrolling device 106, measurements 510 and 512 are recorded, storing the electromagnetic emissions from the processes in the monitored device 104 corresponding to light no longer being emitted (indicated by M3) and the temperature pattern “T3”. Measurements 514 and 516 indicate that the electromagnetic emissions from the processes in the monitored device 104 correspond to a light not being emitted (indicated by M4) and a falling temperature pattern (indicated by T4).

The enrollment records the relationship between the enrollment status data 202 and the enrollment side-channel emission data 210. In one embodiment, several resulting models 530 each representing different enrollment status data may be constructed from the side-channel emission data, shown in FIG. 5A as A1, A2, B1, B2, respectively. These resulting models 530 may be an ensemble of several models built for different side-channel emission data (For example, four models: A1, A2, B1, B2) or fewer models built on the combined data of several different types of side-channel emission data (For example, two models: A={A1,A2} and B={B1, B2}). In another embodiment, the enrollment status data is combined with the side-channel emission data as input to a single model that is sequentially updated (For example, one model: AB={A1, A2, B1, B2}).

FIG. 5B illustrates a monitoring phase profile for an exemplary use case of monitoring the side channel emissions of an IoT lighting device. After the IoT lighting device has been put through the enrollment process, it is now ready for side-channel emissions monitoring to determine the operating state of the IoT lighting device. During the monitoring phase, the verification module 122 communicates with the monitored device 104 to determine the monitored status data 230. At time “TS5”, event 532 identifies that a “light on” has occurred on device “D2” corresponding to monitored device 104. At time “TS7”, event 534 identifies that a “LIGHT OFF” has occurred on device “D2” corresponding to monitored device 104.

In parallel, the verification module 122 communicates with the emissions enrolling device 106 to determine the monitored side-channel emission data 238. At time “TS5 +DELAY”, measurement 536 identifies that “TEMPERATURE” measurement values “T5” were recorded at device “D3”. At time “TS5 +DELAY”, measurement 538 identifies that “ELECTROMAGNETIC” measurement values “M5” were recorded at device “D3”. At time “TS6”, measurement 540 identifies that “TEMPERATURE” measurement values “T6” were recorded at device “D3”. At time “TS6”, measurement 542 identifies that “ELECTROMAGNETIC” measurement values “M6” were recorded at device “D3”. At time “TS7 +DELAY”, measurement 544 identifies that “TEMPERATURE” measurement values “T7” were recorded at device “D3”. At time “TS7 +DELAY”, measurement 546 identifies that “ELECTROMAGNETIC” measurement values “M7” were recorded at device “D3”. At time “TS8”, measurement 548 identifies that “TEMPERATURE” measurement values “T8” were recorded at device “D3”. At time “TS8”, measurement 550 identifies that “ELECTROMAGNETIC” measurement values “M8” were recorded at device “D3”.

The monitored profile 250 records the relationship between the monitored status data 230 and the enrollment side-channel emission data 210. Using the enrollment mapping from FIG. 5B, for measurement 552, the “LIGHT ON” and “TEMPERATURE INCREASE PATTERN” results in model A1 being used, evaluating model 522 for the monitored status data and measurements results in a high probability of a match. Measurement 554 indicates that the model representing the electromagnetic emission side-channel for the “LIGHT ON” event, resulting in the model A2 being applied, producing a moderately high output probability for the obtained electromagnetic emission measurement pattern of an “ELECTROMAGNETIC EMISSION PATTERN A”. Measurement 556 indicates that the model B1 representing the temperature side-channel measurements for the “LIGHT OFF” event produces a high output probability for the temperature measurement pattern of a “TEMPERATURE DECREASE PATTERN”. Measurement 558 indicates that the mapping representing the electromagnetic emission data for the “LIGHT OFF”, using model B2, event produces a high output probability for the electromagnetic emission measurement pattern of an “ELECTROMAGNETIC EMISSION PATTERN B”.

Evaluating the monitored measurements 552, 554, 556, and 558 using the enrollment models A1, A2, B1, and B2, respectively, shows that the models produce a high probability of the device behaving the same as during the enrollment phase.

FIG. 5C shows the same monitoring phase as in FIG. 5B, but with different measurement values. In this case, the temperature characteristics have changed, and the electromagnetic pattern has also changed since enrollment. Because the temperature characteristic has changed, it can be inferred that more heat is being generated at the monitored device 104. Because the electromagnetic characteristic has changed, it can be inferred that the processes within the device have been altered at the monitored device 104, e.g., receiving different input values or producing different output values. As a result, the verification module 122 determines that the monitored device 104 is not operating normally.

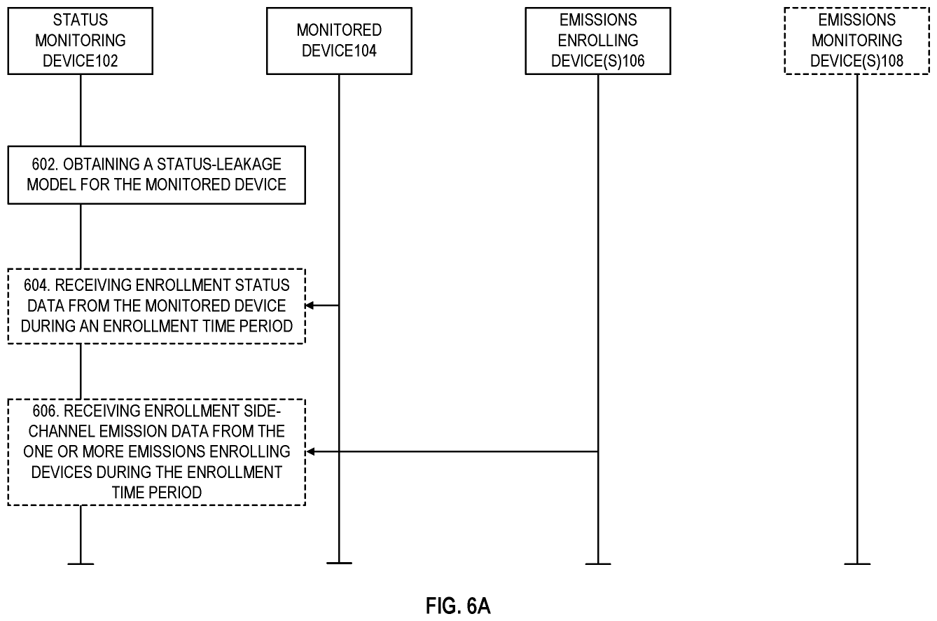

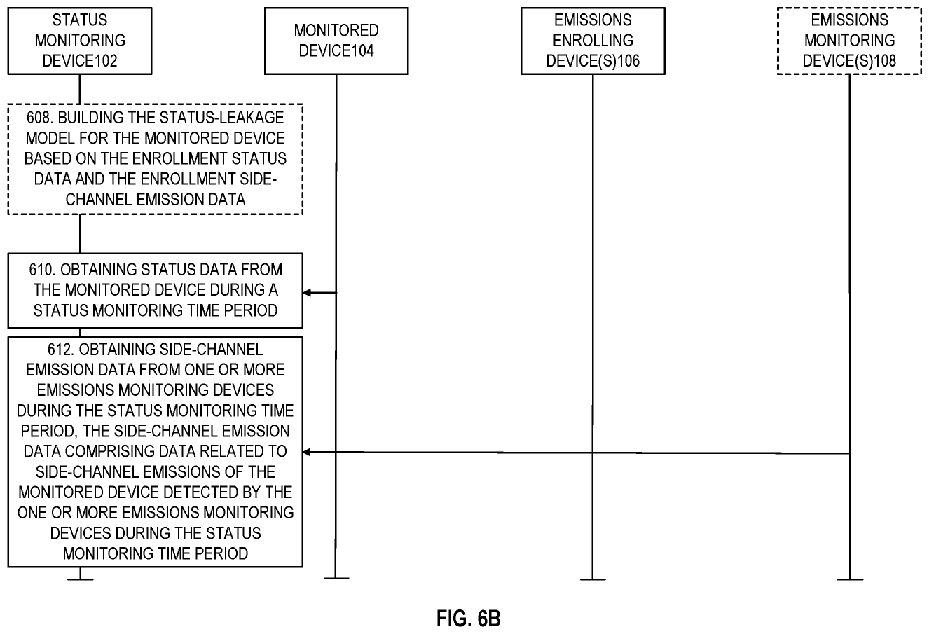

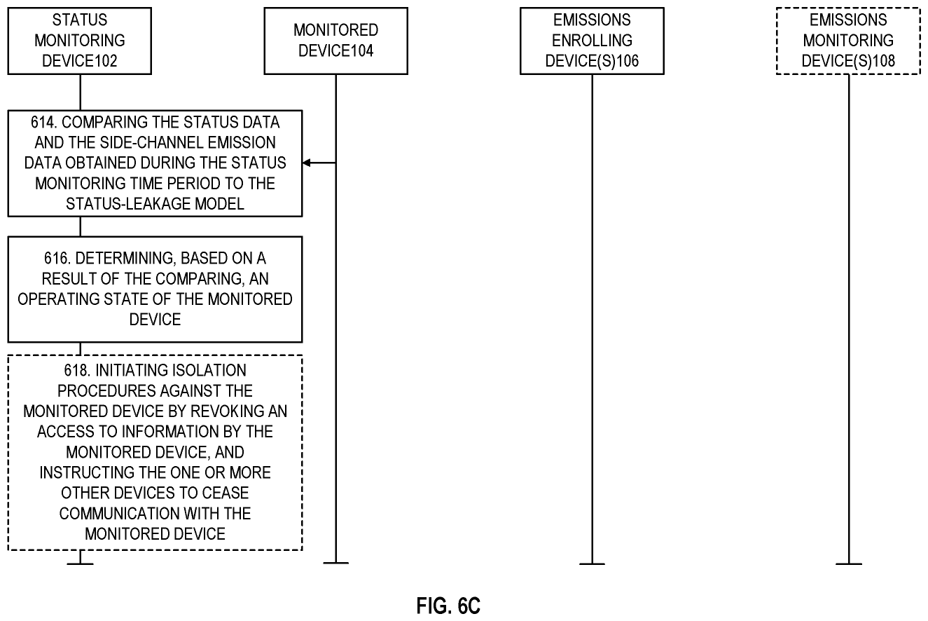

FIG. 6A illustrates the method steps of operating a monitoring device 102 to monitor a status of a monitored device 104 using one or more additional emissions measuring devices 120 to determine if the monitored device 104 is operating normally. The monitored device 104 is the device being monitored, the additional emissions measuring devices 120 are devices used to obtain measurements 144 of the emissions 142 from the monitored device 104, and the monitoring device 102 is the monitoring device communicating with both the monitored device 104 and the additional emissions measuring devices 120. The method includes building a status-leakage model 200 during an enrollment phase and then using that status-leakage model 200 to determine the operating state of the monitored device 104 during a monitoring phase.

At step 602, the verification module 122 obtains a status-leakage model for the monitored device 104 based on enrollment status data 202 received from the monitored device 104 during the enrollment phase and enrollment side-channel emission data 210 received from one or more emissions monitoring devices 108 during the enrollment phase. In some embodiments, the status-leakage model 200 for the monitored device 104 is built on demand based on steps 604-608 below and recorded for later use. In some embodiments, a previously recorded status-leakage model 200 is obtained by using an identifier and/or device type identifying the monitored device 104 and obtaining the status-leakage model 200 for the monitored device 104 based on the identifier. In this embodiment, the status-leakage model 200 may also include setup configuration information which is used to determine the emissions enrolling device 106 and the emissions monitoring device 108 to be used for emissions 142 measurement 144.

At step 604, the verification module 122 receives the enrollment status data 202 from the monitored device 104 during the enrollment phase. The enrollment status data 202 includes an event 204 caused by the execution of instructions on the monitored device 104, a device id 206 identifying the monitored device 104 being enrolled, and a timestamp 208 identifying a time at which the instructions were executed on the monitored device 104 during the enrollment phase.

At step 606, the verification module 122 receives the enrollment side-channel emission data 210 from the one or more emissions monitoring devices 108 during the enrollment phase. The enrollment side-channel emission data 210 includes a measurement type 212 identifying a type of emission 142 being measured, measurement values 214 identifying the value of the measurements 144, a device id 216 identifying the device taking the measurement 144, and a timestamp 218 identifying the time at which the measurement 144 was taken.

FIG. 6B illustrates the additional method steps of operating a monitoring device 102 to monitor the status of a monitored device 104 using one or more emissions monitoring devices 108 to determine the operating state of the monitored device 104. FIG. 6B picks up where FIG. 6A ends.

At step 608, the verification module 122 builds the status-leakage model 200 for the monitored device 104 based on the enrollment status data 202 and the enrollment side-channel emission data 210. Building the status-leakage model 200 includes determining enrollment model 220, which is data about a mapping between the event 204 occurring on the monitored device 104 and the resulting measurement values 214 taken at the emissions enrolling device 106.

At step 610, the verification module 122 obtains monitored status data 230 from the monitored device 104 during the monitoring phase. In some embodiments, obtaining the monitored status data 230 includes transmitting an instruction to the monitored device 104 to execute a process (marked by an event), the execution of the process by the monitored device 104 resulting in changed monitored status data. In some embodiments, obtaining the monitored status data 230 includes transmitting an instruction to the monitored device 104 to perform a reset, receiving additional measurements 144 of the monitored side-channel emission data 238 from one of the one or more emissions monitoring devices 108, and determining from the additional measurements 144 of the monitored side-channel emission data 238 that the reset was performed by the monitored device 104.

At step 612, the verification module 122 obtains monitored side-channel emission data 238 from one or more emissions monitoring devices 108 during the monitoring phase, the monitored side-channel emission data 238 comprising data related to side-channel emissions of the monitored device 104 detected by the one or more emissions monitoring devices 108 during the monitoring time period. The monitored (and enrollment) side-channel emission data 238 may include any one or more of a power consumption of the monitored device 104, electromagnetic emissions from the monitored device 104, timing of processor or externally observable events of the monitored device 104, optical emissions from the monitored device 104, acoustic emissions from the monitored device 104, and heat emissions from the monitored device 104. Emissions 142 may be impacted by environmental factors, including weather, humidity, air pressure, and lighting conditions.

FIG. 6C illustrates the additional method steps of operating a monitoring device 102 to monitor the status of a monitored device 104 using one or more emissions monitoring devices 108 to determine the operating state of the monitored device 104. FIG. 6C picks up where FIG. 6B ends.

At step 614, the verification module 122 compares the monitored status data 230 and the monitored side-channel emission data 238 to the status-leakage model 200. In some embodiments, comparing the monitored side-channel emission data 238 to the status-leakage model 200 includes determining an enrollment profile 236 based on the status-leakage model 200, determining a monitored profile 250 based on the monitored status data 230 received from the monitored device 104 and monitored side-channel emission data 238 received from the one or more emissions monitoring devices 108, and comparing the enrollment profile to the monitored profile.

At step 616, the verification module 122 determines, based on a result of the comparing, an operating state of the monitored device 104. In some embodiments, the operating state is one of operating normally and not operating normally. A monitored device 104 that is deemed to be not operating normally may have been compromised based on malware.

At step 618, in response to determining the operating state of the monitored device 104 is not normal, verification module 122 initiates isolation procedures against the monitored device 104. In some embodiments, initiating the isolation procedures comprises revoking access to information by the monitored device 104 and instructing one or more devices to cease communication with the monitored device 104.

A first advantageous use case is in an industrial environment with, possibly heterogeneous, industrial equipment handled by one or several controllers using a SCADA protocol. In this scenario, the monitoring device 102 may be a single controller device or a controller system depending on the setup. The monitored device 104 is a device, system or component monitored by the controller. The additional device may be an autonomous device, such as a UAV, UGV or UUV which can receive instruction on what to monitor from the controller. The emissions enrolling device 106/emissions monitoring device 108 may also be specialized equipment handled by an operator. The monitoring device 102 may periodically request autonomous emissions monitoring devices 108 to monitor certain equipment. This can give a first indication if a monitored device 104 is not functioning as intended. Furthermore, the monitoring device 102 can request additional monitoring if strange behavior is observed, e.g., where the observed operation, service level or communication patterns differs from the ordinary. The industrial use case can be applied in both factories and outdoor environments where the equipment is spread over a large area, e.g., in a critical infrastructure use case where power/water management equipment are controlled remotely. It is particularly beneficial to have autonomous devices in this scenario which can travel vast distances without human interaction.

Another advantageous use case is to utilize above method in a smart home scenario. In this case, the monitoring device 102 may be a home control panel, e.g. Google Nest, which is utilized to control and monitor different appliances within a home. The monitored device 104 may in case be a smart plug, a robot vacuum cleaner, a smart toaster, etc. The additional device may be a user device, such as a smartphone or a smartwatch, which can utilize its magnetometer to make coarse-grained measurement of the EM emissions from the monitored device 104. The monitoring device 102 may periodically, and/or when seeing abnormal status data or communication behavior from the monitored device 104, send a request to the set of emissions enrolling device 106 in the household for one of them to be placed next to the monitored device 104. The method can identify misbehaving monitored device 104, e.g., infected by malware, making it possible to determine and isolate said devices without needing any other equipment than the everyday devices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

Those skilled in the art will recognize improvements and modifications to the embodiments of the present disclosure. All such improvements and modifications are considered within the scope of the concepts disclosed herein.

1. A method of operating a monitoring device to monitor a status of a monitored device, the method comprising:
obtaining a status-leakage model for the monitored device;
obtaining status data from the monitored device during a status monitoring time period;
obtaining side-channel emission data from one or more emissions monitoring devices during the status monitoring time period, the side-channel emission data comprising data related to side-channel emissions of the monitored device detected by the one or more emissions monitoring devices during the status monitoring time period;
comparing the status data and the side-channel emission data obtained during the status monitoring time period to the status-leakage model; and
determining, based on a result of the comparing, an operating state of the monitored device.

2. The method of claim 1, wherein obtaining the status-leakage model comprises:
receiving enrollment status data from the monitored device during an enrollment time period;
receiving enrollment side-channel emission data from the one or more emissions enrolling devices during the enrollment time period; and
building the status-leakage model for the monitored device based on the enrollment status data and the enrollment side-channel emission data.

3. The method of claim 2, wherein obtaining the status-leakage model further comprises:
transmitting an instruction to the one or more emissions enrolling devices that identifies a location at which the enrollment side-channel emissions of the monitored device should be measured, prior to receiving the enrollment side-channel emission data from the one or more emissions enrolling devices during the enrollment time period.

4. The method of claim 2, wherein obtaining the status-leakage model further comprises:
establishing a first secure communication channel between the monitoring device and the monitored device prior to receiving the enrollment status data from the monitored device during the enrollment time period; and
establishing a second secure communication channel between the monitoring device and the one or more emissions enrolling devices prior to receiving the enrollment side-channel emission data from the one or more emissions enrolling devices during the enrollment time period.

5. The method of claim 2, wherein obtaining the status-leakage model further comprises:
resetting the monitored device to a known state prior to receiving the enrollment status data from the monitored device during the enrollment time period.

6. The method of claim 2, wherein obtaining the status-leakage model further comprises:
transmitting a message to at least one of the one or more emissions enrolling devices requesting a start to side-channel monitoring of the monitored device.

7. The method of claim 6, wherein the message comprises information identifying one or more of:
an identity and/or a geolocation of the monitored device;
a desired side-channel emission of the monitored device to measure;
an instruction identifying a location at which the enrollment side-channel emissions of the monitored device should be measured;
an instruction identifying a technique to employ in measurement of the enrollment side-channel emissions of the monitored device; and
a side-channel measurement capability of the one or more emissions enrolling devices.

8. The method of claim 7, wherein the message further comprises additional information that identifies:
a duration of the enrollment side-channel emissions to be measured; and
a time at which a scheduled process will occur on the monitored device.

9. The method of claim 1, wherein the status-leakage model comprises:
the enrollment status data obtained during the enrollment time period;
the enrollment side-channel emission data obtained during the enrollment time period; and
a mapping between the enrollment status data obtained during the enrollment time period and the enrollment side-channel emission data obtained during the enrollment time period.

10. The method of claim 1, wherein the status-leakage model further comprises:
a type of side-channel emission being measured by the side-channel monitoring by the one or more emissions enrolling devices;
a setup of one of the one or more emissions enrolling devices performing measurement of the enrollment side-channel emissions;
a location for side-channel emissions measurement by the one or more emissions enrolling devices; and
a disposition for side-channel emissions measurement by the one or more emissions enrolling devices.

11. The method of claim 1, wherein obtaining the side-channel emission data comprises:
transmitting a message to the one or more emissions monitoring devices requesting side-channel monitoring of the monitored device;
receiving the status data from the monitored device and the side-channel emission data measured by the one or more emissions monitoring devices;
combining the status data and the side-channel emission data to form a combined data; and
comparing the combined data to a status-leakage model tuple.

12. The method of claim 112 wherein obtaining side-channel emission data further comprises:
transmitting an instruction to the monitored device to execute a process, the execution of the process by the monitored device resulting in a changed monitored status data.

13. The method of claim 11, further comprising:
transmitting an instruction to the monitored device to perform a reset;
receiving additional measurements of the side-channel emission data from one of the one or more emissions monitoring devices; and
determining from the additional measurements of the side-channel emission data that the reset was performed by the monitored device.

14. The method of claim 1, wherein comparing the status data and the side-channel emission data to the status-leakage model comprises:
performing a comparison of the status data and the side-channel emission data to the status-leakage model using a machine learning model where the side-channel emission data is evaluated as anomalous when the machine learning model produces a low likelihood of the side-channel emission data when correlated to status data.

15. The method of claim 1, wherein determining the operating state of the monitored device comprises:
determining that the operating state of the monitored device is one of operating normally and not operating normally.

16. The method of claim 1, wherein comparing the status data and the side-channel emission data to the status-leakage model comprises:
determining an enrollment profile based on the status-leakage model;
determining a monitored profile based on the status data received from the monitored device and monitored side-channel emission data received from the one or more emissions monitoring devices; and
comparing the enrollment profile to the monitored profile.

17. The method of claim 16, wherein comparing the enrollment profile to the monitored profile comprises:
determining an enrollment mapping between the enrollment status data and the enrollment side-channel emission data; and
determining a monitored mapping between the status data and the side-channel emission data.

18. The method of claim 1, wherein determining the operating state of the monitored device comprises:
determining the operating state of the monitored device based on the result of the comparing and one or more external factors.

19-27. (canceled)

28. A monitoring device for monitoring a status of a monitored device the monitoring device comprising:
a communication interface; and
a controller component associated with the communication interface the controller component comprising one or more processors configured to cause the monitoring device to:
obtain a status-leakage model for the monitored device;
obtain status data from the monitored device during a status monitoring time period;
obtain side-channel emission data from one or more emissions monitoring devices during the status monitoring time period, the side-channel emission data comprising data related to side-channel emissions of the monitored device detected by the one or more emissions monitoring devices during the status monitoring time period;
compare the status data and the side-channel emission data obtained during the status monitoring time period to the status-leakage model; and
determine, based on a result of the comparing, an operating state of the monitored device.

29. (canceled)

30. A non-transitory computer-readable medium comprising instructions executable by one or more processors of a monitoring device for monitoring a status of a monitored device the monitoring device, whereby the monitoring device is operable to:
obtain a status-leakage model for the monitored device;
obtain status data from the monitored device during a status monitoring time period;
obtain side-channel emission data from one or more emissions monitoring devices during the status monitoring time period, the side-channel emission data comprising data related to side-channel emissions of the monitored device detected by the one or more emissions monitoring devices during the status monitoring time period;
compare the status data and the side-channel emission data obtained during the status monitoring time period to the status-leakage model; and
determine, based on a result of the comparing, an operating state of the monitored device.
